(19) United States
(12) Patent Application Publication
(10) Pub. No.: US 2026/0299653 A1
(43) Pub. Date: Oct. 1, 2026

(54) Portable Data Center Hardcase with Convertible Lid System and Integrated Pole Mounting

(71) Applicant: HiveRadar Inc., Toronto (CA)

(72) Inventor: Rahul Narsimhan, Toronto (CA)

(21) Appl. No.: 19/578,311

(22) Filed: Mar. 25, 2026

Related U.S. Application Data
(60) Provisional application No. 63/777,477, filed on Mar. 25, 2025.

(51) Int. Cl. G06F 1/18; G06F 21/79

(52) U.S. Cl. CPC G06F 1/182; G06F 21/79

(57) ABSTRACT

Provided is a portable datacenter hardcase comprising a convertible lid system and an integrated pole mounting system for enhanced field utility. Said convertible lid system further comprises two reinforced lids with aluminum reinforcement plates, each including storage cavities for articulating leg assemblies. A first lid converts to a bench using work bench deployment legs. A second lid attaches to the deployed bench as an elevated work surface supporting up to 8 pounds when properly mounted. EDC deployment support legs elevate the hardcase from the ground for either horizontal or vertical deployment with side access to internal components. The integrated pole mounting system further comprises a pole receiver structurally connected to an internal structural frame, with a threaded receiver, centering puck for pole alignment, and tethered protective cap.

### FIELD OF THE INVENTION

The present invention relates generally to portable datacenter enclosures. Particularly, the present invention is a portable rackmount hardcase having a convertible lid system that transforms into functional work surfaces and an integrated pole mounting system for deploying elevated equipment.

### BACKGROUND OF THE INVENTION

Field operations, emergency response scenarios, and remote deployments frequently require portable computing infrastructure capable of rapid deployment. Conventional portable datacenter solutions typically consist of ruggedized enclosures containing computing equipment, networking hardware, and power distribution components. While these solutions address the basic need for transportable computing resources, they present several operational challenges in field environments.

First, personnel deploying such equipment often lack adequate work surfaces and seating in remote or austere locations. Operators may be forced to work on the ground or improvise workstations from available materials, reducing operational efficiency and ergonomic safety.

Second, wireless communication equipment such as access points, antennas, cellular gateways, and beacons perform optimally when elevated above ground level to improve signal propagation and coverage area. Conventional portable datacenters require separate tripods, masts, or mounting structures to achieve proper equipment elevation, adding to the overall system weight, complexity, and deployment time.

Third, the various accessories and deployment hardware required for field operations—support legs, pole sections, mounting brackets, and cables—must typically be transported and managed separately from the main enclosure, increasing the risk of lost or forgotten components and extending setup time.

Accordingly, there exists a need for an integrated portable datacenter solution that addresses these operational challenges through a unified system design that minimizes separate components while maximizing field utility.

### SUMMARY OF THE INVENTION

The present invention provides a portable datacenter hardcase with enhanced functionality for field operations through two primary innovations: a convertible lid system and an integrated pole mounting system.

According to one aspect of the invention, the portable datacenter hardcase includes a convertible lid system wherein at least two reinforced lids are configured to serve multiple functions. Each lid includes internal storage cavities for housing deployment hardware including leg assemblies. A first lid is configured to convert into a bench capable of supporting an adult user when deployed with a first set of articulating legs. A second lid is configured to function as an elevated work surface that attaches to the deployed bench via an articulating arm and channel mechanism. The leg assemblies stored within the lids include a first set configured to support the bench lid at an ergonomic seating height and a second set configured to elevate the datacenter hardcase from the ground.

According to another aspect of the invention, the portable datacenter hardcase includes an integrated pole mounting system disposed on a sidewall of the hardcase. The pole mounting system includes a pole receiver integrated with an internal structural frame, wherein the structural frame provides rigidity sufficient to support elevated equipment at heights enabled by the telescoping pole. The pole receiver includes a threaded receiver configured to receive a telescoping pole, a centering puck disposed within the threaded receiver to facilitate pole alignment during installation, and a tethered protective cap to seal the threaded receiver when the pole is not installed. The pole mounting system enables deployment of elevated equipment such as wireless access points, antennas, cellular gateways, beacons, cameras, solar panels, and other mountable equipment at heights that improve signal acquisition and coverage without requiring separate mounting structures.

The combination of the convertible lid system and integrated pole mounting system transforms the portable datacenter hardcase from a simple transport enclosure into a complete field workstation, enabling rapid deployment of computing infrastructure along with functional seating, work surfaces, and elevated equipment mounting within a single integrated package.

### BRIEF DESCRIPTION OF THE DRAWINGS

FIG. 1a is a front elevational view of the present invention.

FIG. 1b is a rear elevational view of the present invention.

FIG. 2a is a front elevational view of the present invention in a closed position.

FIG. 2b is a front elevational view of the present invention in a removed lid position.

FIG. 2c is a front elevational view of a lid assembly of the present invention.

FIG. 2d is a front elevational view of an embodiment of the present invention.

FIG. 2e is a front elevational view of an embodiment of the present invention.

FIG. 2f is a rear elevational view of an embodiment of the present invention.

FIG. 3 is a perspective view of the pole mounting system of the present invention describing a threaded receiver, centering puck, and protective cap configuration.

FIG. 4 is an isometric view of the present invention deployed in a horizontal orientation.

FIG. 5 is an illustration of a user seated on a bench of the present invention.

FIG. 6 is an isometric view of an embodiment of the present invention deployed in a horizontal orientation and extended telescoping pole.

FIG. 7 is a front top left perspective view of an embodiment of the present invention.

FIG. 8 is an isometric view of an embodiment of the present invention deployed in a horizontal orientation on support legs and caster wheels.

FIG. 9a is a top plan view of the internal components of the present invention.

FIG. 9b is a front top perspective view of the internal components and accessory drawer of the present invention.

FIG. 9c is a rear top perspective view of the internal components and accessory drawer of the present invention.

FIG. 10 is a front right perspective view of a sliding rack assembly of the present invention.

FIG. 11a is a front elevational view of a hardware rack of the present invention.

FIG. 11b is a rear elevational view of a hardware rack of the present invention. FIG. 12a is a sectional view of an internal structure frame and rack mounting system of the present invention.

FIG. 12b is a sectional view of an internal structure frame and rack mounting system of the present invention.

FIG. 13 is a front right perspective view of a rack assembly of the present invention.

FIG. 14a is an exploded view of a lid assembly of the present invention.

FIG. 14b is a front elevational view of a lid assembly of the present invention.

FIG. 14c is an exploded view of a lid assembly of the present invention.

FIG. 14d is a front elevational view of a lid assembly of the present invention.

FIG. 15 is an exploded view of internal structural frame components and base assembly of the present invention.

FIG. 16 is a front elevational view of a lid assembly of the present invention deployed as a bench.

FIG. 17 is a right top perspective view of a lid assembly of the present invention deployed as a bench.

FIG. 18 is a schematic view of an embodiment of the present invention.

FIG. 19 is a perspective view of a caster wheel component of the present invention.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header. All illustrations of the drawings are for the purpose of describing selected versions of the present invention and are not intended to limit the scope of the present invention. The present disclosure includes many aspects and features. Moreover, while many aspects and features relate to, and are described in the context of the disclosed use cases, embodiments of the present disclosure are not limited to use only in this context.

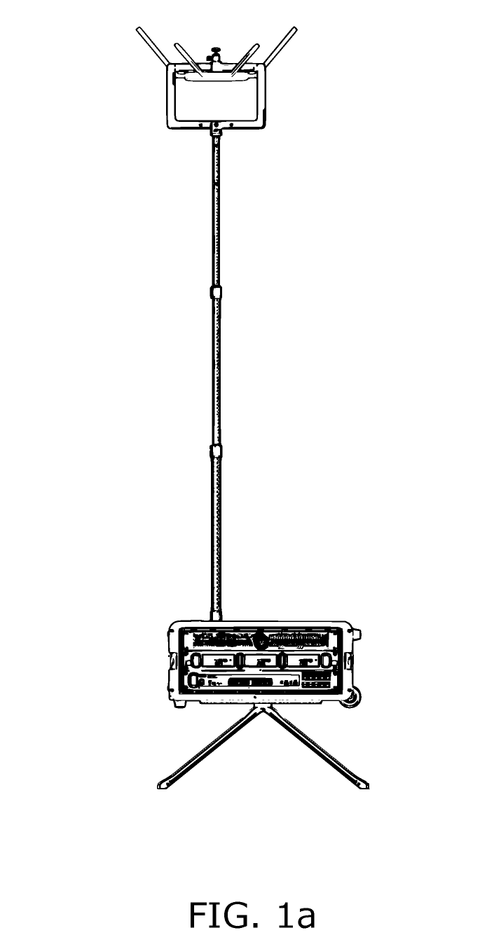

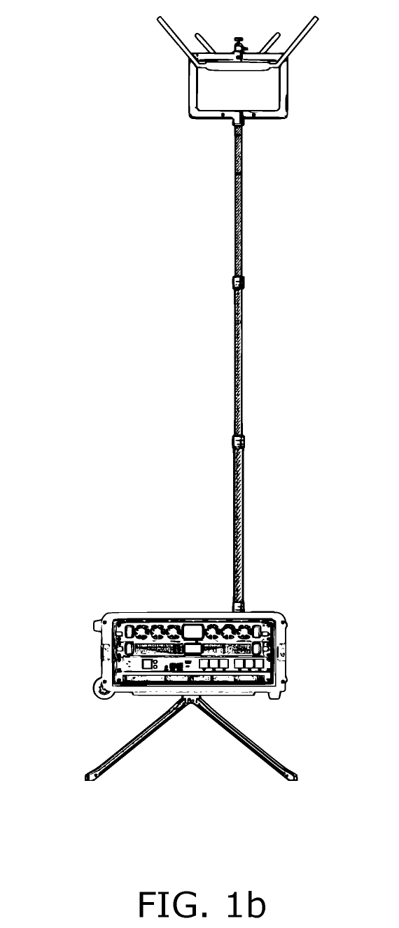

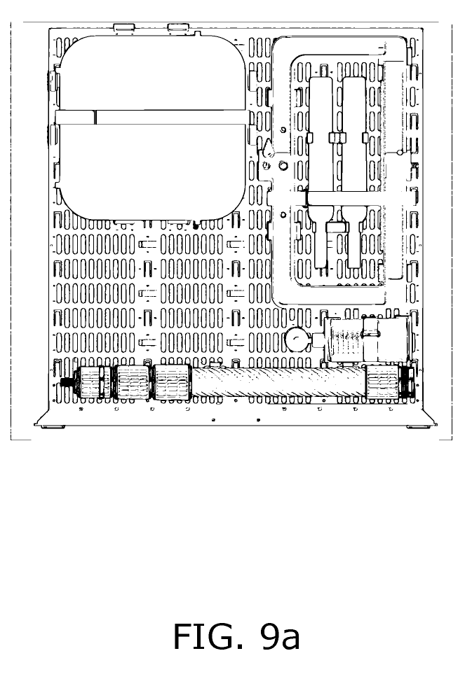

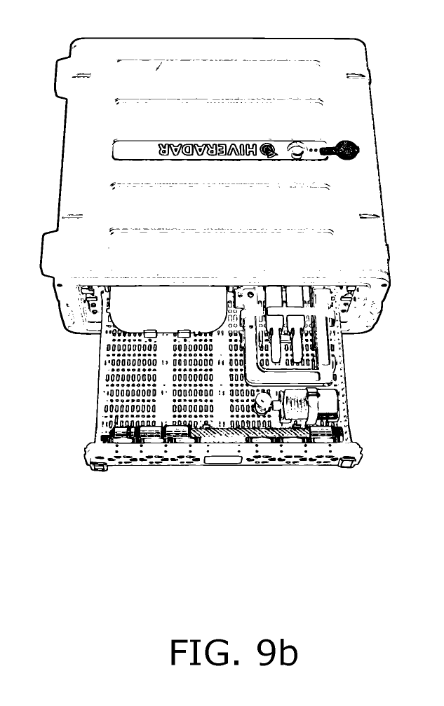

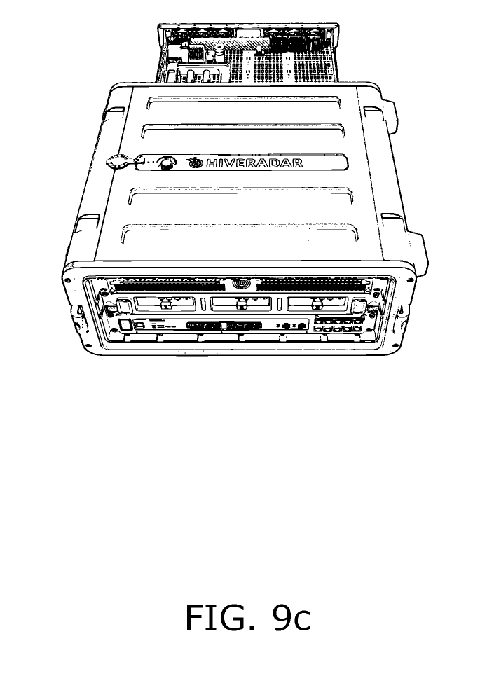

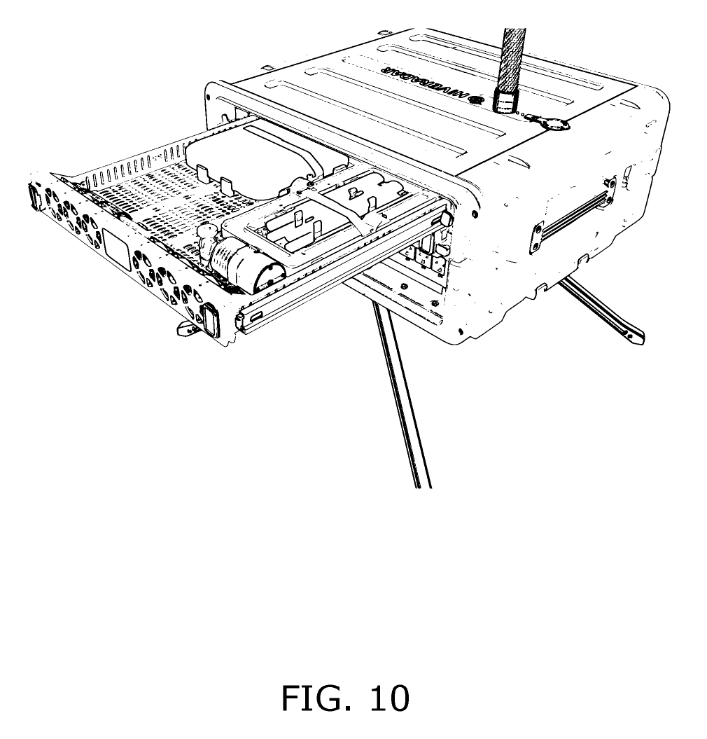

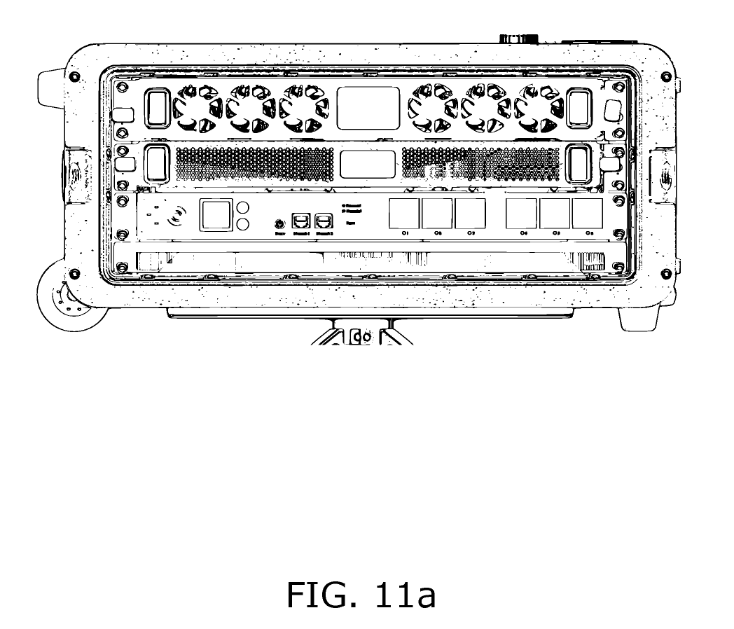

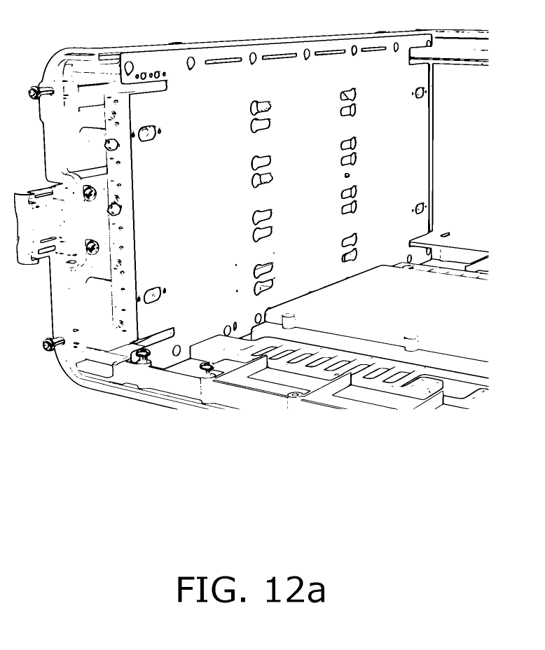

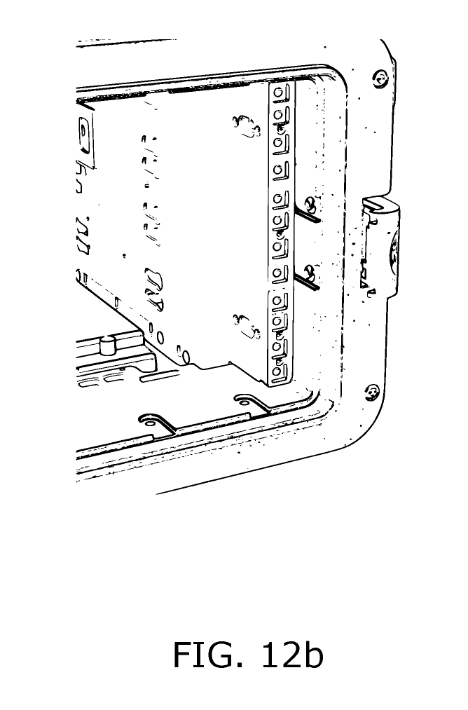

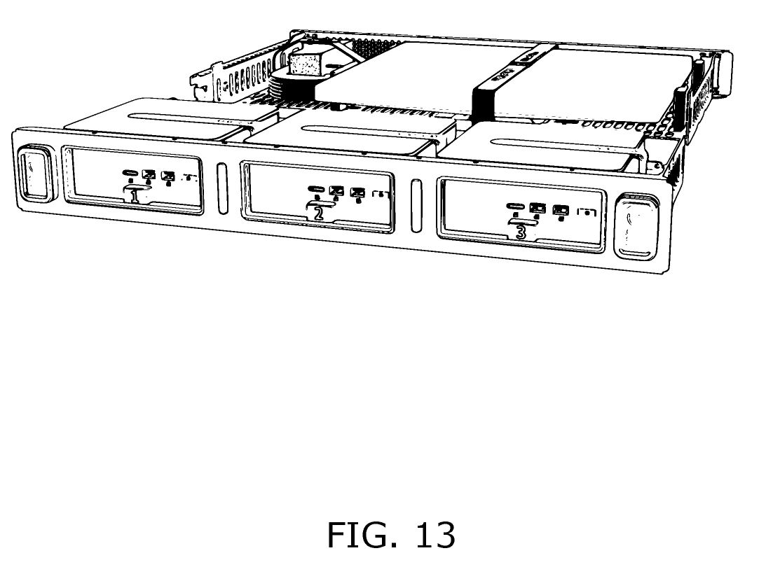

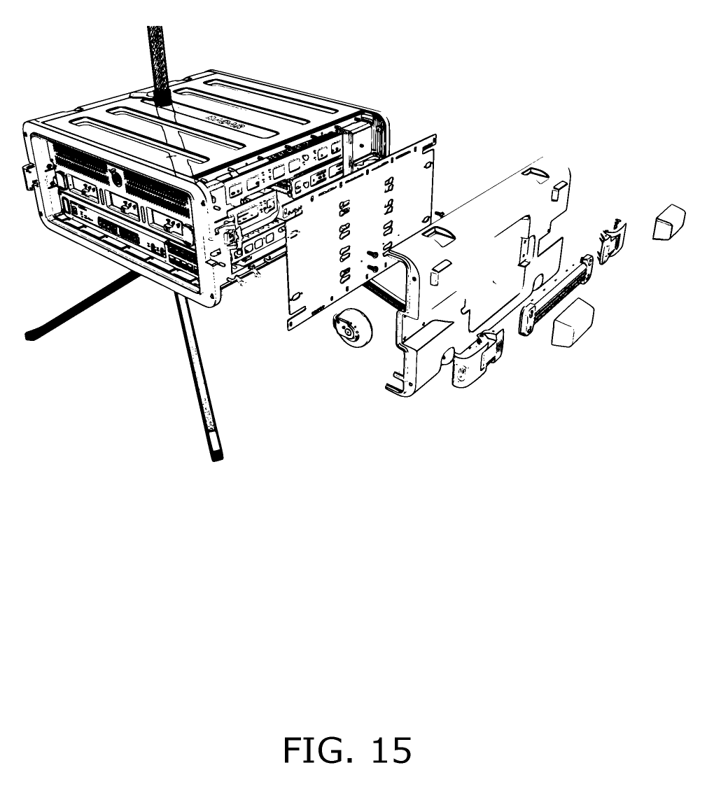

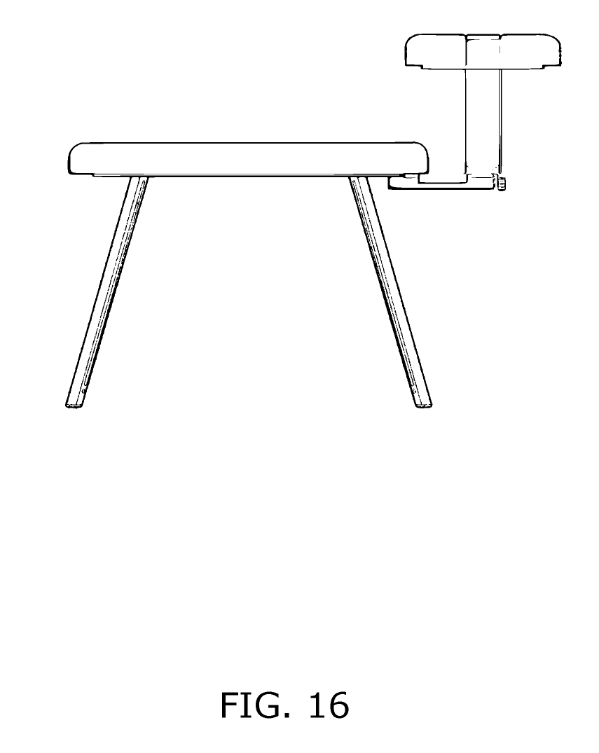

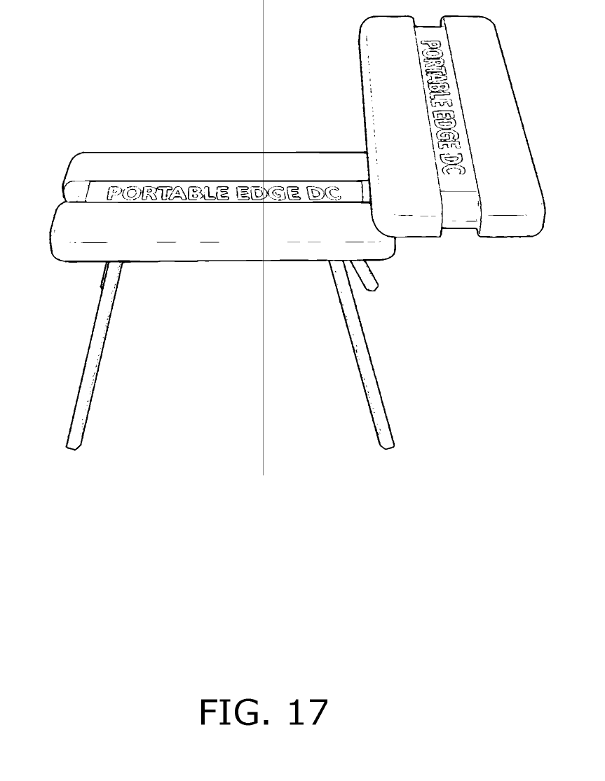

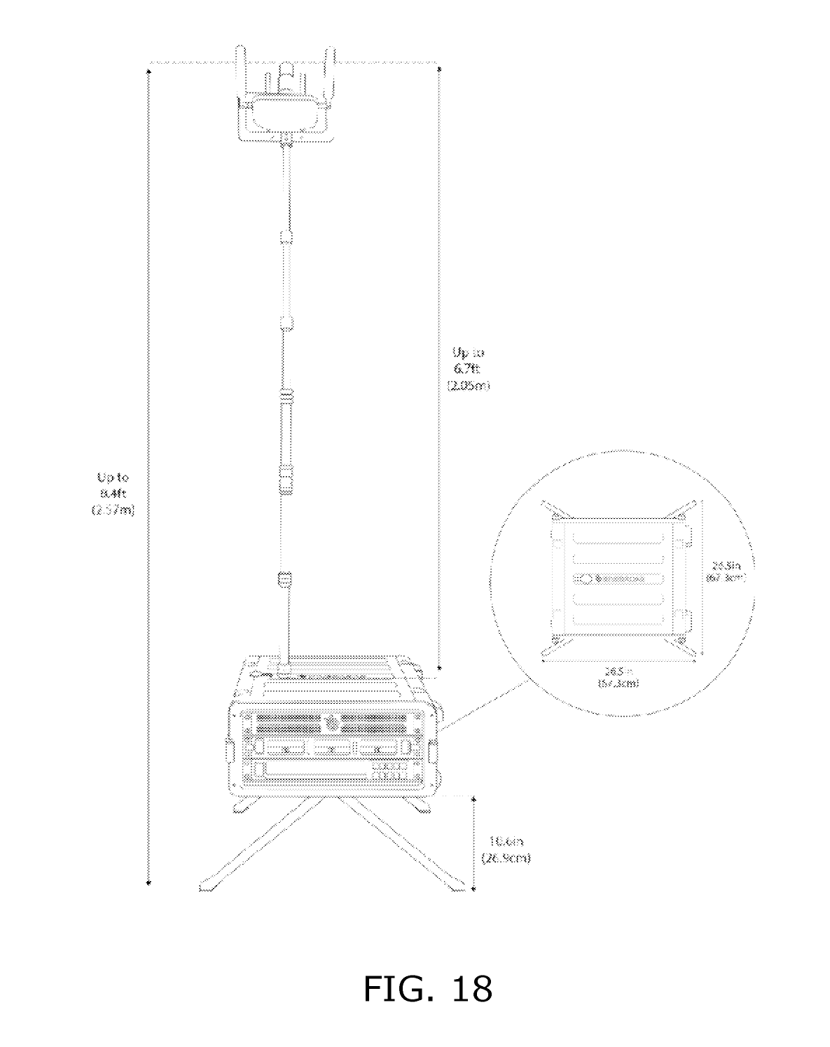

Referring generally to FIG. 1a-19, the portable datacenter hardcase according to the present invention comprises a ruggedized enclosure configured to house rack-mounted equipment including computing hardware, networking equipment, power distribution, and storage drawers. Said storage drawers are configured to store deployment accessories including pole sections, mounting brackets, cables, and connectivity equipment. Said hardcase is constructed from high molecular weight polyethylene formed by injection molding, providing impact resistance and environmental protection for the internal components.

Said hardcase further comprises an internal structural frame fabricated from aluminum and secured to the interior surfaces of said hardcase by mechanical fasteners. Said structural frame provides mounting points for internal rack equipment and structural reinforcement for the overall assembly. Importantly, said structural frame also serves as the structural foundation for the integrated pole mounting system. A pole receiver is integrated as part of said structural frame and attaches thereto, wherein said structural frame provides the rigidity necessary to support equipment elevated to heights achievable with a telescoping pole. Without said structural frame, said hardcase’s shell alone would not provide sufficient structural support for such elevated equipment loads.

Said hardcase is configured for deployment in a horizontal orientation, wherein said hardcase is elevated from the ground surface by articulating legs and supported with access panels on opposite sides of said hardcase. When said hardcase is deployed horizontally on said articulating legs, access to internal drawers and components is provided from the sides of said hardcase where the lids attach. In various embodiments, said hardcase further comprises wheels disposed on the base for transport and latches securing the lids to the main body during transport. Further, in various embodiments, said wheels are clipped onto said articulating legs.

In various embodiments, said hardcase is configured for deployment alternatively in a vertical orientation. In a vertical deployment embodiment, the present invention comprises a modified handle assembly, an integrated threaded pole base, anchor points for supporting leg assemblies in a vertical configuration. In some embodiments, a vertical deployment embodiment further comprises a protective cap. Such embodiments provide alternative benefits such as height which can positively affect the effectiveness of the hardware for the user.

In the preferred embodiment of the present invention, said hardcase provides 4U (four rack units) of internal mounting space. While embodiments of the present invention may differ in their internal computing hardware configurations, various embodiments share identical external form factor and deployment functionality with respect to the convertible lid system and integrated pole mounting system of the present invention. Future model variants may leverage the same or similar components of the present invention.

### Convertible Lid System

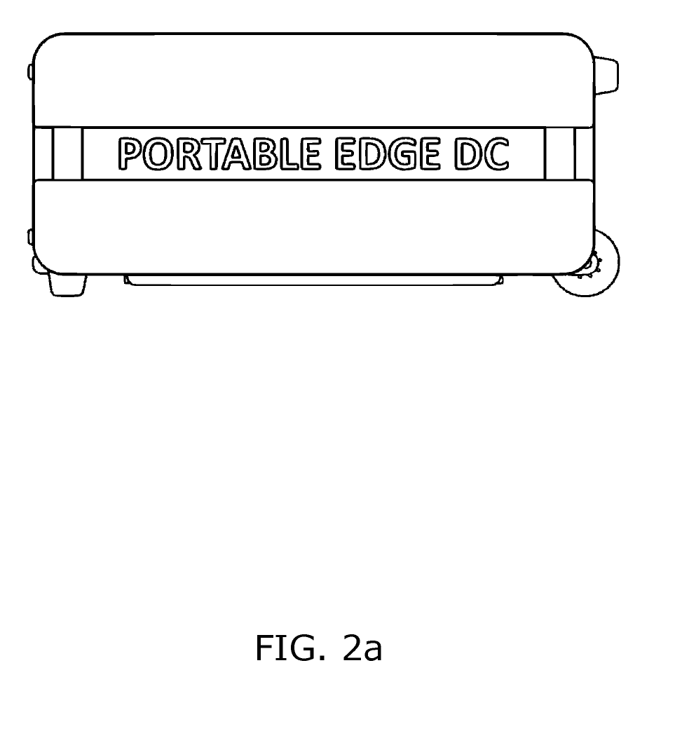

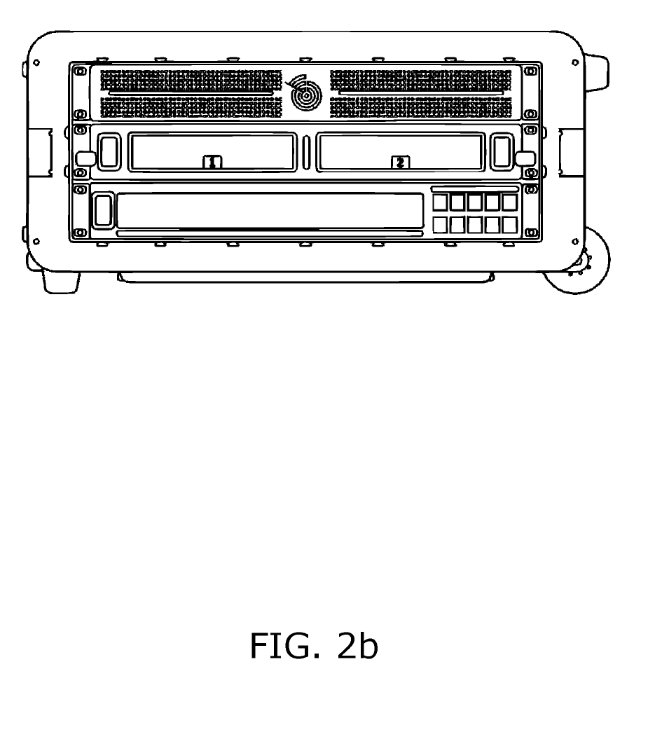

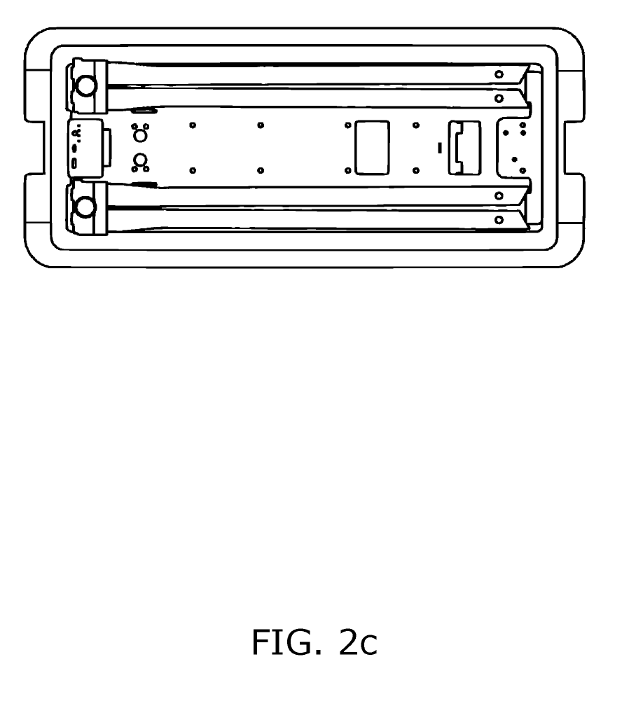

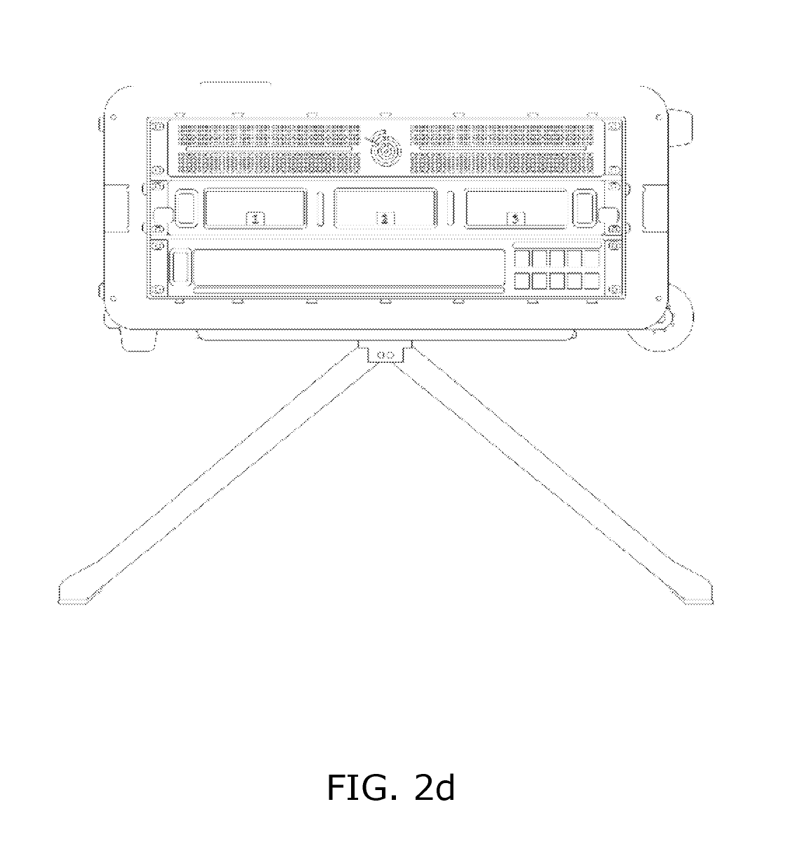

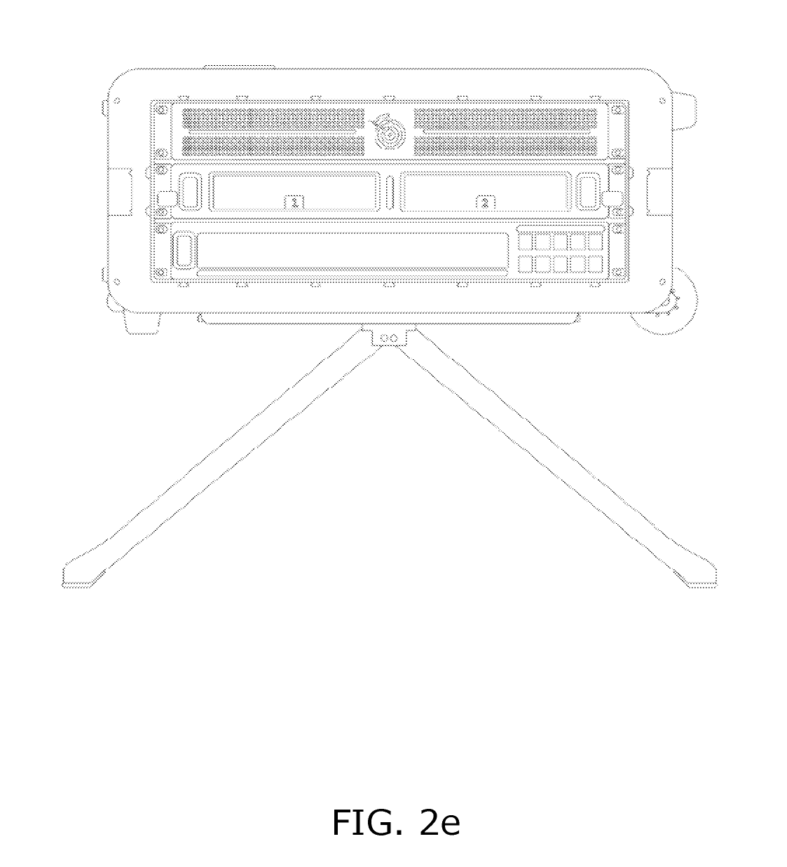

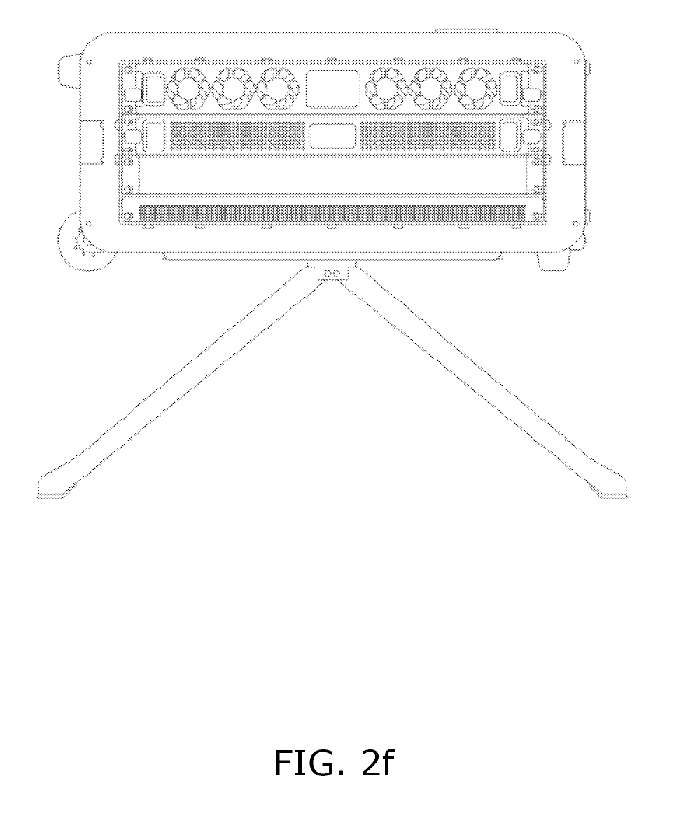

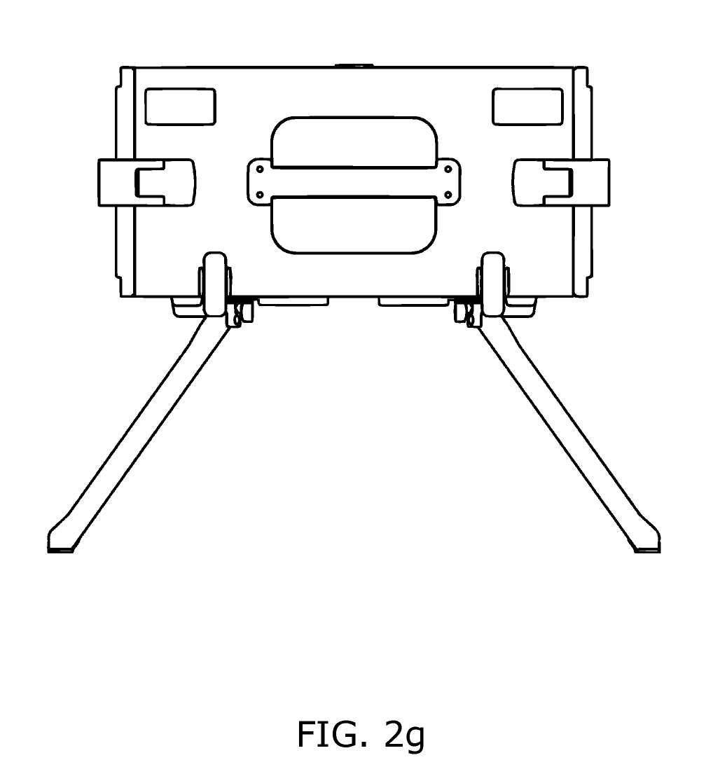

Referring to FIGS. 2a, 2c, 4, 5, 14a, 14b, 14c, 14d, 16 and 17, the convertible lid system of the present invention comprises two lids, each configured to serve multiple functions beyond simple enclosure protection. Each lid includes an internal reinforcement plate fabricated from aluminum and configured to distribute applied loads across the lid structure. The reinforcement plate enables each lid to support substantial weight when deployed as a work surface.

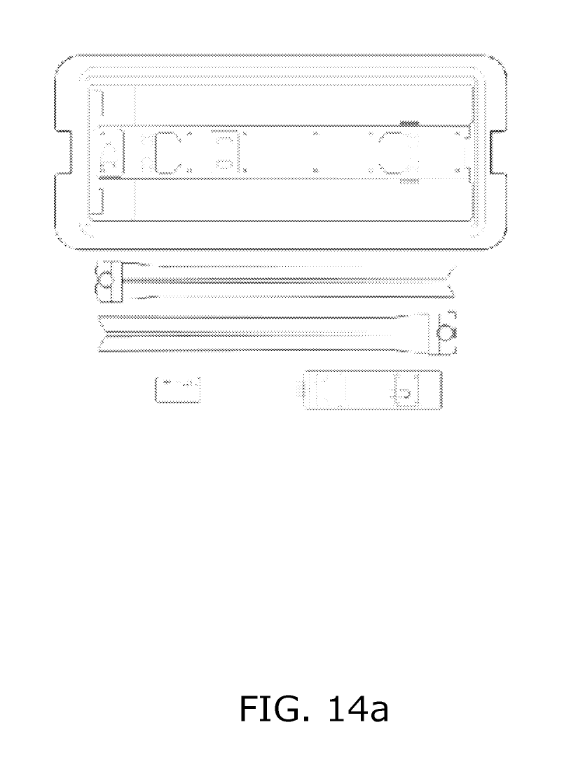

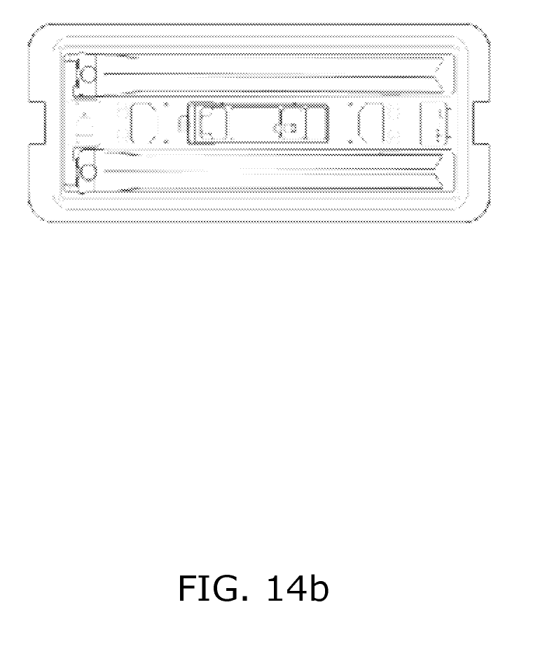

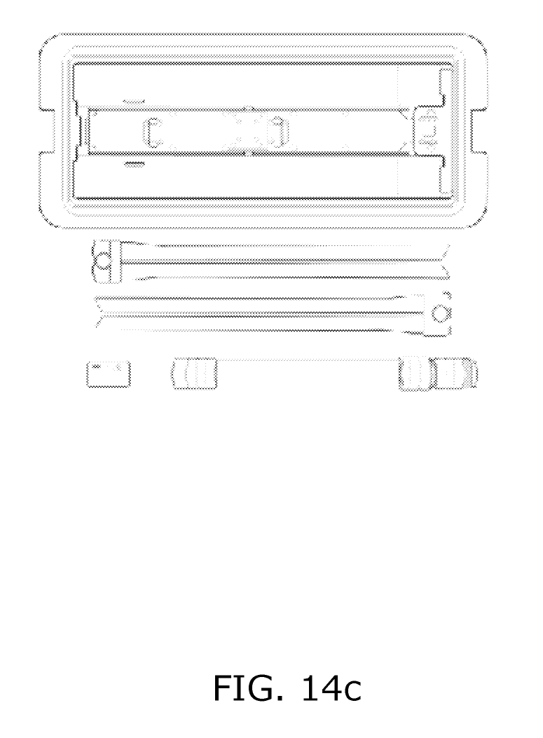

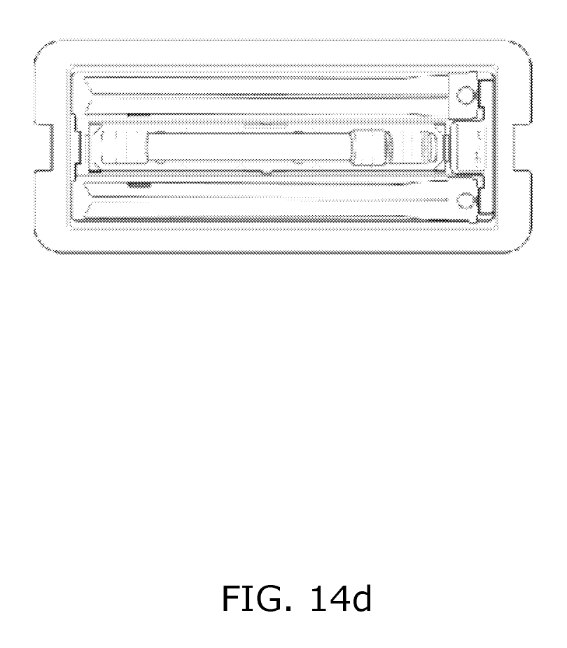

Each lid includes internal storage cavities configured to house a complete leg assembly. As shown in FIGS. 2c and 14a-14d, said storage cavities are shaped to receive said articulating legs in a nested configuration that protects said articulating legs during transport while maintaining the low-profile form factor of the lid. The leg storage cavities are specifically configured to receive leg assemblies. In the preferred embodiment of the present invention, a first lid stores the work bench deployment legs and includes the work bench mounting plate. In the preferred embodiment of the present invention, a second lid stores the EDC deployment support legs and a carbon fiber pole section. In some embodiments, articulating legs can be stored in either first or second lid if desired by the user.

Said hardcase comprises two distinct sets of articulating legs. A first leg set, designated as work bench deployment legs, is stored within said first lid and is configured to support said first lid in a bench configuration at an ergonomic seating height. A second leg set, designated as EDC deployment support legs, is stored within said second lid and is configured to attach to anchor points on the said hardcase’s body to elevate the datacenter from the ground during deployment.

Said leg sets are functionally distinct and not interchangeable. Said work bench deployment legs have a straight profile from attachment point to ground contact, while the EDC deployment support legs include an angled section at the foot to optimize stability when supporting said hardcase. Said leg sets are further differentiated by markings identifying their intended function and, in various embodiments, to be able to attach said wheels if desired. In use, a user may prefer to optimize stability without using said wheels, while in other cases may prefer to attach said wheels for mobility.

Each leg assembly comprises machined aluminum construction with a substantially square cross-section having extruded channels. Said leg assemblies attach to their respective anchor points via a clamp-style mechanism with alignment features. A twist knob adjacent to the clamp secures the leg assembly in the deployed position.

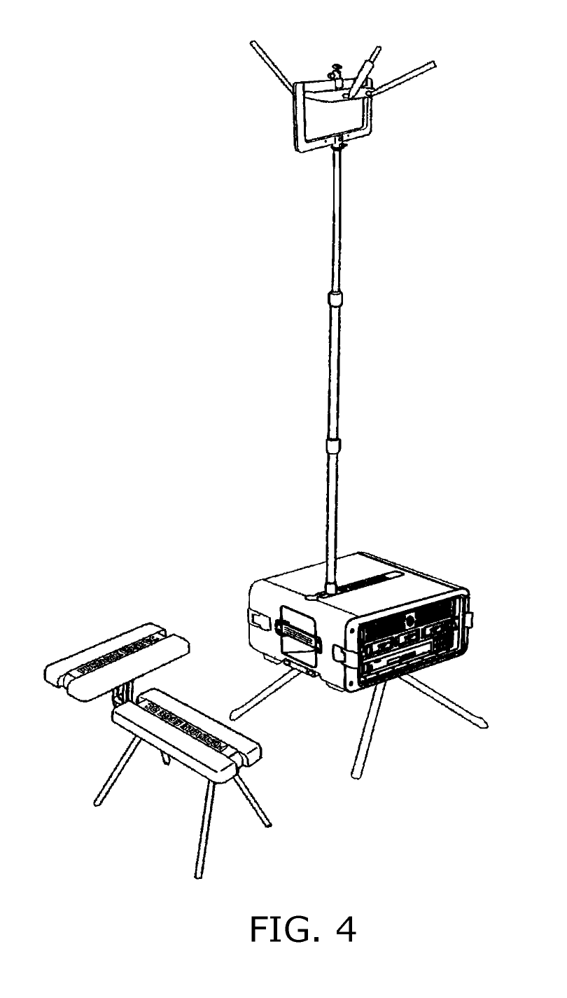

Referring to FIGS. 4, 5, 16 and 17, when deployed in bench configuration, the work bench deployment legs support said first lid at an angle of approximately 60 degrees relative to the ground, providing a stable seating surface capable of supporting an adult user weighing up to 220 pounds.

When the EDC deployment support legs are deployed to support said hardcase, the EDC deployment support legs extend at an angle of approximately 40 degrees relative to the ground surface, providing stable elevation of the hardcase for side access to internal components while maintaining a low center of gravity for stability.

### Work Surface Assembly

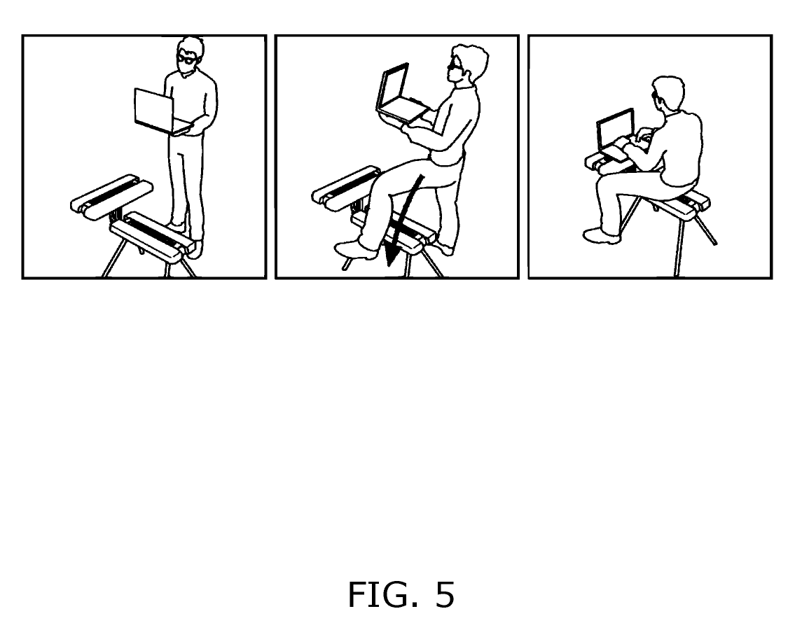

Referring to FIG. 4 and 5, the convertible lid system further includes a work surface assembly enabling said second lid to function as an elevated work surface attached to the deployed bench. Said work surface assembly comprises a work surface arm that is stored on the underside of said first lid when not in use. Said work surface arm is secured in its storage position by a fastener engaging a work surface anchor disposed on the bench lid.

To deploy said work surface, the work surface arm is removed from storage and attached to a work surface anchor point on said first lid via a linear sliding motion until the arm engages. Said second lid includes articulating arms disposed adjacent to the carbon fiber pole storage area. These articulating arms rotate approximately 90 degrees outward from their stored position. Said second lid is then slid onto the work surface arm channel via the articulating arms. A knob on the work surface arm is tightened to secure the work surface in position. The work surface configuration supports loads up to 8 pounds when properly mounted, suitable for laptop computers and field documentation.

As shown in FIG. 5, the complete field workstation configuration provides an operator with a bench seat facing an elevated work surface, enabling extended operation in remote environments without requiring external furniture or support equipment.

### Integrated Pole Mounting System

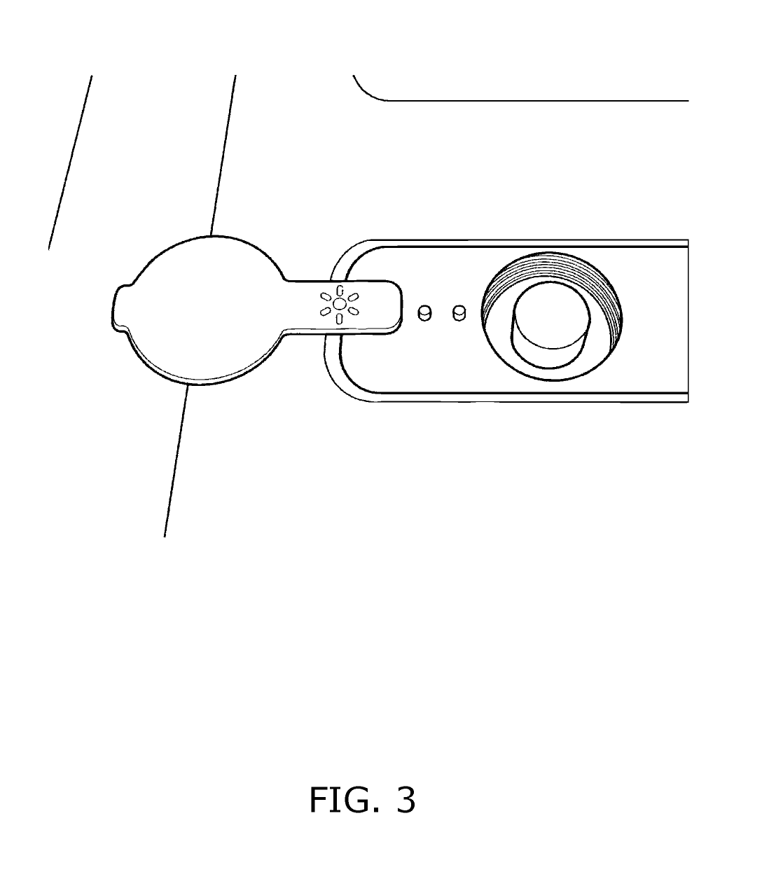

Referring to FIG. 3, 6, and 7, the integrated pole mounting system comprises a pole receiver integrated with said structural frame and accessible from a sidewall of the hardcase. Said pole receiver includes a threaded receiver configured to receive a telescoping pole via threaded engagement. Because said pole receiver is structurally connected to said structural frame, the system provides sufficient rigidity to support elevated equipment at heights achievable with the fully extended telescoping pole, a capability that would not be achievable if the pole receiver were mounted only to the hardcase shell.

Said threaded receiver includes a centering puck disposed within the threaded aperture. Said centering puck provides alignment guidance during pole installation, ensuring the pole is properly centered and oriented before threading engagement begins. This alignment feature facilitates rapid and reliable pole installation, particularly in field conditions where precise manual alignment may be challenging.

Said pole mounting system further includes a protective cap configured to seal the threaded receiver when the pole is not installed. Said protective cap is tethered to said hardcase via a permanent attachment point disposed adjacent to said threaded receiver, preventing loss of the cap during field operations.

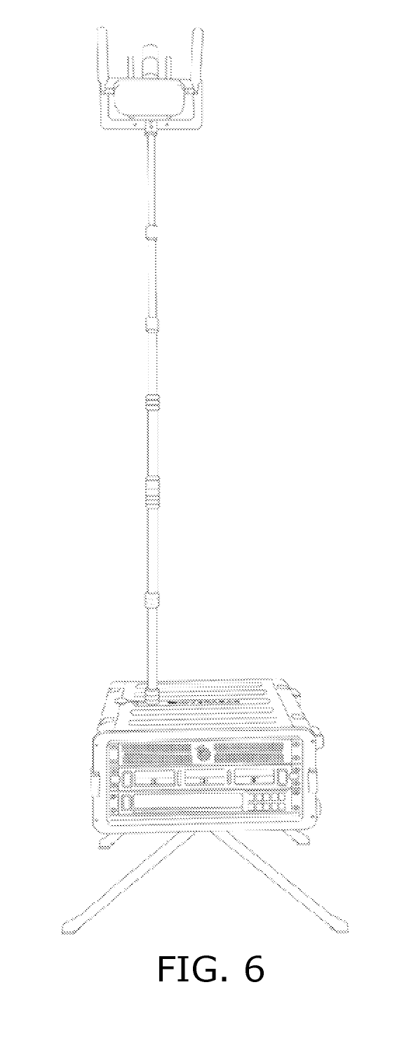

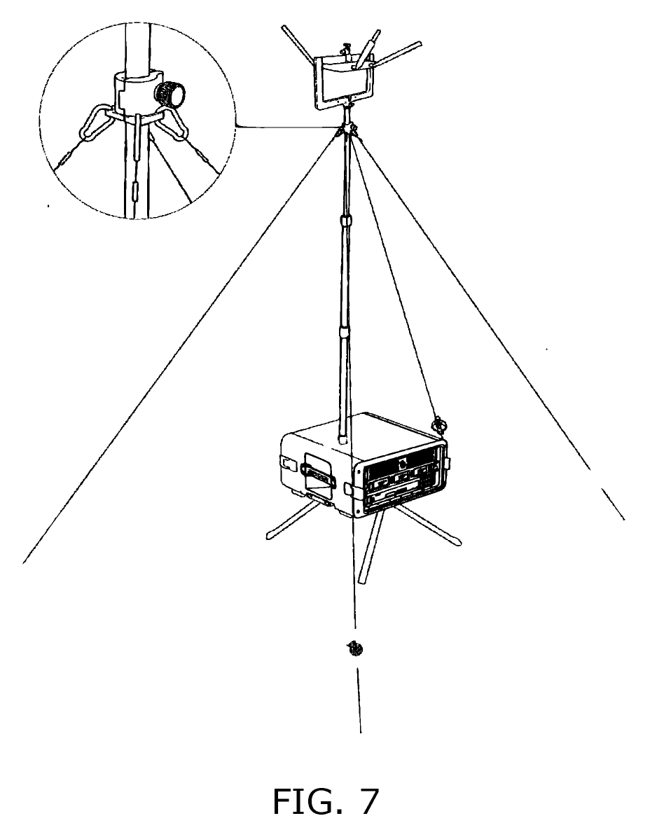

Referring to FIG. 6 and 7, said telescoping pole comprises carbon fiber construction. Said integrated pole mounting system includes two pole components: a main telescoping pole section having a threaded base for engagement with the pole receiver and an extension pole section that attaches before the main pole to achieve full deployed height. One pole section is stored within a lid storage cavity and the other is stored within a storage drawer inside the enclosure. Specific storage arrangement can vary by embodiment and configuration. When fully extended with both pole sections, said integrated pole mounting system achieves a height of approximately 8.4 feet (257 cm) from ground level, including a T-bar bracket at the upper end. The telescoping sections are secured via twist-lock mechanisms.

Said T-bar bracket disposed at the upper end of the pole provides a mounting platform for equipment such as wireless access points, antennas, cellular gateways, beacons, cameras, solar panels, and other mountable equipment. The T-bar includes a standard 1/4-inch-20 tripod mount for attachment of compatible equipment. The elevated mounting position enables improved signal propagation for wireless communication equipment and enhanced visibility for beacons, cameras, and other mountable equipment.

Referring to FIG. 7, an embodiment of the present invention comprises a guy wire stabilization system comprising four guy wires extending from anchor points on the pole to ground stakes or other anchor points. Said guy wires include tension adjustment mechanisms and carabiner clips for rapid deployment and adjustment. Said guy wires provide enhanced stability for the extended pole, particularly in windy conditions or when supporting heavier equipment loads.

### Integrated Storage System

Referring to FIGS. 2c, 14a, 14b, 14c, and 14d, each lid comprises dedicated storage cavities and compartments for deployment hardware and accessories. The primary storage cavities are configured to house the respective leg assemblies in a protected nested configuration.

Throughout various embodiments, one of the lid assemblies includes a dedicated storage area for a carbon fiber pole section (either a main telescoping pole or an extension pole), while the other pole section is stored within a storage drawer inside the enclosure. In some embodiments, each lid includes an Energybar LED power module bay for partner and tradeshow configurations.

### Additional Components

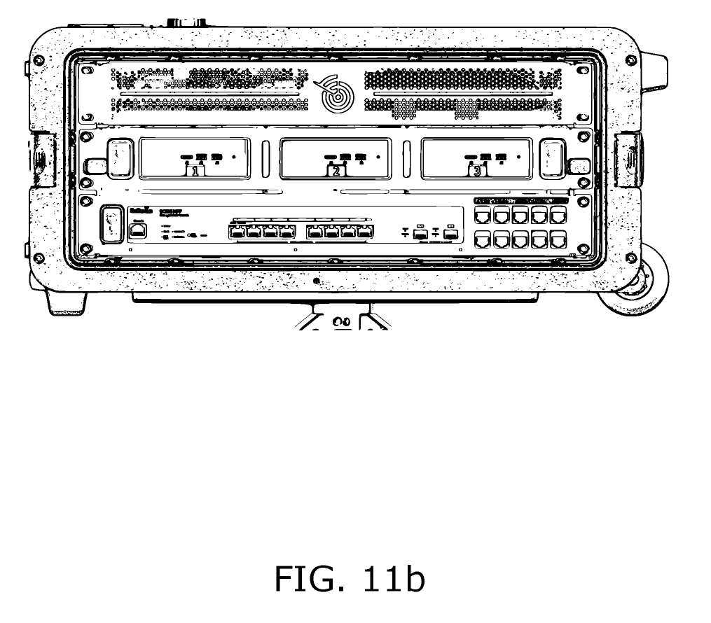

Referring to FIGS. 1a, 1b, 11a, and 11b, said hardcase includes integrated LED illumination providing both aesthetic appearance and functional status indication. The LED illumination is disposed on exterior surfaces of said hardcase and internal rack components.

Referring to FIGS. 14a, 14b, 14c, and 14d, each lid assembly includes a light-diffusing acrylic panel and illuminated component plate disposed beneath a brand identity plate, providing illuminated branding when the system is powered.

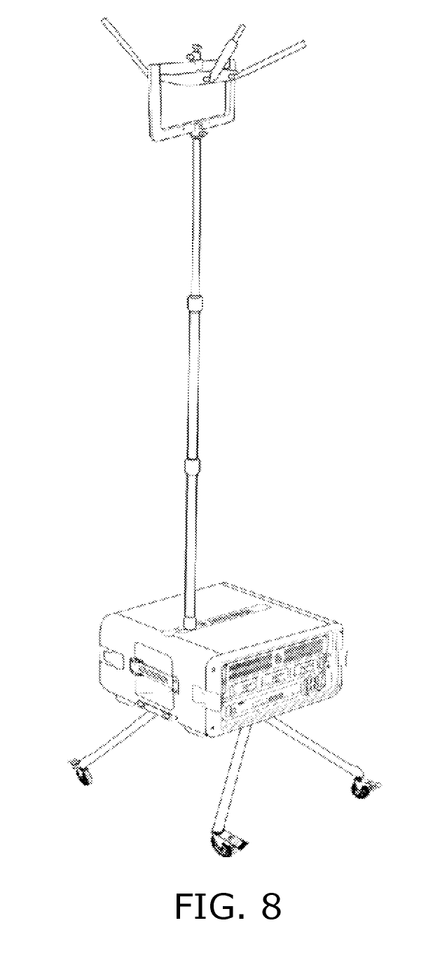

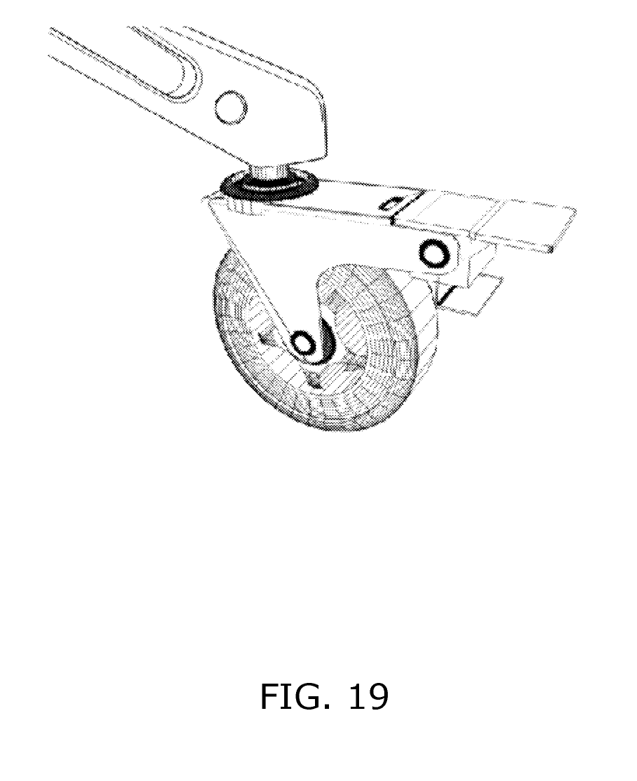

Referring to FIG. 8 and 19, the support legs include anchor points for attachment of caster wheels, enabling mobility of the deployed datacenter within a work area. In some embodiments, said caster wheels further comprise locking mechanisms to secure the datacenter in position during operation.

Said hardcase accommodates various internal configurations including 4U rack space as shown in FIG. 2d and 2e. Internal components comprise compute nodes, network switches, power distribution units, uninterruptible power supplies, and retractable equipment shelves, configured according to operational requirements.

In various embodiments, the present invention further comprises an integrated display module on an exterior or interior surface of said hardcase. Said display module is configured to provide real-time operational status, system health telemetry, network connectivity status, and other telemetry data for the field-deployed edge datacenter.

Although the invention has been explained in relation to its preferred embodiment, it is to be understood that many other possible modifications and variations can be made without departing from the spirit and scope of the invention.

What is claimed is:

1. A datacenter hardcase comprising:
a hardcase body;
a structural frame;
a plurality of storage drawers;
a plurality of lids; and
a plurality of leg assemblies.

2. The datacenter hardcase of claim 1:
wherein each lid of said plurality of lids further comprises an internal reinforcement plate.

3. The datacenter hardcase of claim 1:
wherein said plurality of lids further comprises at least one internal storage cavity;
wherein said plurality of leg assemblies is contained within said at least one internal storage cavity; and
wherein a first lid of said plurality of lids contains a work bench deployment leg assembly of said plurality of leg assemblies and a work bench mounting plate.

4. The datacenter hardcase of claim 1:
wherein said plurality of lids further comprises at least one internal storage cavity;
wherein said plurality of leg assemblies is contained within said at least one internal storage cavity; and
wherein a second lid of said plurality of lids contains a deployment support leg assembly of said plurality of leg assemblies.

5. The datacenter hardcase of claim 1, further comprising:
a pole mounting system, further comprising:
a threaded pole receiver;
a centering puck;
a protective cap;
a telescoping pole; and
a T-bar bracket;
wherein said threaded pole receiver is integrated into said structural frame; and
wherein said telescoping pole further comprises a threaded base.

6. The datacenter hardcase of claim 5, further comprising:
a guy wire stabilization system;
tension adjustment mechanisms; and
carabiner clips.

7. The datacenter hardcase of claim 1, further comprising:
an LED illumination system; and
a plurality of light diffusing acrylic panels;
wherein each light diffusing acrylic panel of said plurality of light diffusing acrylic panels is contained within each lid of said plurality of lids.

8. The datacenter hardcase of claim 1, further comprising:
caster wheels.

9. A datacenter hardcase comprising:
a hardcase body;
a structural frame;
a plurality of storage drawers;
a plurality of lids; and
a plurality of leg assemblies;
wherein said plurality of lids further comprises at least one internal storage cavity;
wherein said plurality of leg assemblies is contained within said at least one internal storage cavity;
wherein a first lid of said plurality of lids contains a work bench deployment leg assembly of said plurality of leg assemblies and a work bench mounting plate; and
wherein each lid of said plurality of lids further comprises an internal reinforcement plate.

10. The datacenter hardcase of claim 9:
wherein said plurality of lids further comprises at least one internal storage cavity;
wherein said plurality of leg assemblies is contained within said at least one internal storage cavity; and
wherein a second lid of said plurality of lids contains a deployment support leg assembly of said plurality of leg assemblies.

11. The datacenter hardcase of claim 9, further comprising:
a pole mounting system, further comprising:
a threaded pole receiver;
a centering puck;
a protective cap;
a telescoping pole; and
a T-bar bracket;
wherein said threaded pole receiver is integrated into said structural frame; and
wherein said telescoping pole further comprises a threaded base.

12. The datacenter hardcase of claim 11, further comprising:
a guy wire stabilization system;
tension adjustment mechanisms; and
carabiner clips.

13. The datacenter hardcase of claim 11:
wherein said hardcase body is deployed in a horizontal orientation.

14. The datacenter hardcase of claim 11:
wherein said hardcase body is deployed in a vertical orientation.

15. The datacenter hardcase of claim 9, further comprising:
an LED illumination system; and
a plurality of light diffusing acrylic panels;
wherein each light diffusing acrylic panel of said plurality of light diffusing acrylic panels is contained within each lid of said plurality of lids.

16. The datacenter hardcase of claim 9, further comprising:
caster wheels.

17. A datacenter hardcase comprising:
a hardcase body;
a structural frame;
a plurality of storage drawers;
a plurality of lids;
a plurality of leg assemblies; and
caster wheels;
wherein said plurality of lids further comprises at least one internal storage cavity;
wherein said plurality of leg assemblies is contained within said at least one internal storage cavity;
wherein a first lid of said plurality of lids contains a work bench deployment leg assembly of said plurality of leg assemblies and a work bench mounting plate;
wherein a second lid of said plurality of lids contains a deployment support leg assembly of said plurality of leg assemblies; and
wherein each lid of said plurality of lids further comprises an internal reinforcement plate.

18. The datacenter hardcase of claim 17, further comprising:
a pole mounting system, further comprising:
a threaded pole receiver;
a centering puck;
a protective cap;
a telescoping pole;
a T-bar bracket;
a guy wire stabilization system;
tension adjustment mechanisms; and
carabiner clips.
wherein said threaded pole receiver is integrated into said structural frame;
wherein said telescoping pole further comprises a threaded base; and
wherein said hardcase body is deployed in a horizontal orientation.

19. The datacenter hardcase of claim 17, further comprising:
an LED illumination system; and
a plurality of light diffusing acrylic panels;
wherein each light diffusing acrylic panel of said plurality of light diffusing acrylic panels is contained within each lid of said plurality of lids.

20. The datacenter hardcase of claim 17, further comprising:
a display module;
wherein said display module.is found on said hardcase body.
